(19) United States
(12) Patent Application Publication
(10) Pub. No.: US 2009/0083779 A1
(43) Pub. Date: Mar. 26, 2009

(54) DIGITAL CONTENT PROMOTION

(76) Inventors: Yevgeniy Eugene Shteyn, Cupertino, CA (US); Gabriel Mendoza, Los Gatos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/860,029

(22) Filed: Sep. 24, 2007

(51) Int. Cl. H04N 7/16

(52) U.S. Cl. 725/14

(57) ABSTRACT

Embodiments of digital content promotion are disclosed.

### BACKGROUND

The introduction of the videocassette recorder (VCR) in the 1970s ushered in a new era in which television shows, movies, and other programs could be played in the home of a consumer. Previously, a consumer typically was limited to viewing a movie in a theatre. However, a consumer currently enjoys many formats and/or venues available for viewing movies and other digital content. Nevertheless, creators, producers, and distributors of such movies and other media still face the same age-old challenge of determining where and when to focus their resources to maximize their profit.

### BRIEF DESCRIPTION OF THE DRAWINGS

FIG. 1 is a diagram illustrating a digital content promotion system, according one embodiment of the present disclosure.

FIG. 2 is a block diagram a digital content promotion system, according to one embodiment of the present disclosure.

FIG. 3 is a flow diagram illustrating a method of promoting digital content, according to one embodiment of the present disclosure.

### DETAILED DESCRIPTION

In the following detailed description, reference is made to the accompanying drawings which form a part hereof, and in which is shown by way of illustration specific embodiments in which the subject matter of the present disclosure may be practiced. In this regard, directional terminology, such as “top,” “bottom,” “front,” “back,” “leading,” “trailing,” etc., is used with reference to the orientation of the Figure(s) being described. Because components of embodiments of the present disclosure can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

Embodiments of the present disclosure promote a digital content unit, via a network-based service provider, using interactive promotional displays such as a digital content sample. In one embodiment, a digital content unit includes, but is not limited to, a movie, a television program (or series of programs), instructional videos, music videos or concerts, etc. In one embodiment, the service provider provides a participation mechanism to encourage and facilitate interaction of the viewer with the digital content sample. In one aspect, the participation mechanism enables a viewer to share digital content samples with other viewers, as well as to rate the digital content sample. The viewer rates the quality and/or likeability of the digital content sample. In one embodiment, a viewer makes a prediction of the future commercial success of the digital content unit based on their viewing of the digital content sample.

In another embodiment, the service provider operates a reward mechanism to reward the viewers for participating in viewing, sharing, or rating the digital content sample, as well as to reward a viewer for making predictions (of future commercial success) about the digital content unit. In one aspect, viewers making accurate predictions regarding the future commercial success receive additional rewards or higher-value rewards.

In one embodiment, viewers making accurate predictions regarding the future commercial success of a digital content unit are rewarded through publicizing their participation and accuracy. Accordingly, in one aspect, the network service provider calculates a rating for the accuracy of an individual viewer or of a group of viewers in predicting future commercial success for a digital content unit. Next, a ranking of the relative accuracy among those respective individual viewers or groups of viewer is determined and then published by the service provider. In another aspect, this publication regarding the accuracy and/or relative rank of the respective viewers is made within a predetermined time frame including, but not limited to, a release date of the digital content unit, a predetermined day of the week, and/or a predetermined time of day. Accordingly, the service provider rewards accurately predictive viewers while simultaneously providing further promotion of one or more digital content units by attracting viewers to return to the participation mechanism on a regular basis to observe the ratings or rankings, as well as to view other promotional material such as other digital content samples.

In one embodiment, the reward mechanism acts as part of a feedback loop in which a positive reaction by viewers (in the form of comments, positive ratings, a large number of predictions of success, and high volumes of sharing the digital content samples) to a digital content sample is used to provide similar digital sample units. Conversely, a negative reaction by viewers (in the form of comments, low ratings, few predictions of success, and low volumes of sharing the digital content samples) to a digital content sample is used as a signal to provide an alternative digital content sample for the same digital content unit. In one embodiment, multiple different digital content samples are offered to viewers for the same digital content unit and a comparison is made by the service provider as to which digital content sample is the most effective at promoting a positive reaction from viewers. In one embodiment the effectiveness of a digital content sample is determined by an evaluation provided by select viewers that have a consistently high accuracy in predicting the future commercial success (or lack of success) for digital content units.

In one aspect, the a more effective digital content sample will have a higher frequency and/or increased volume (a higher number of viewers) of sharing the digital content sample, as well as potentially having a higher number of positive ratings received at the service provider for the digital content sample. In another aspect, a more effective digital content sample is identified by a higher number of viewers making positive predictions and/or accurate predictions of a future commercial success regarding the digital content unit represented by the digital content sample. The type of feedback (e.g., whether negative or positive) regarding a digital content unit, based on the viewers' behavior or reaction to that digital content unit, is used by a content provider to adjust promotional resources (such as a digital content sample), production resources, and distribution resources to increase the commercial success of the digital content unit.

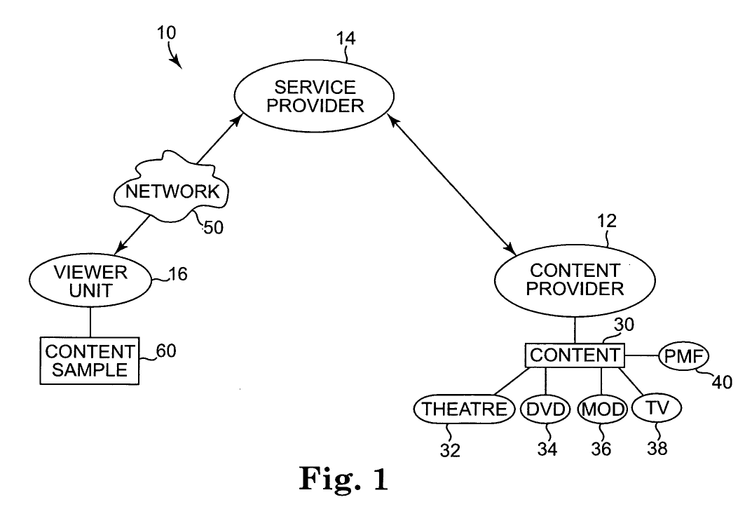

These embodiments, and additional embodiments, are described in association with FIGS. 1-3.

FIG. 1 is a diagram illustrating a digital content promotion system, according to one embodiment of the present disclosure. As illustrated in FIG. 1, system 10 comprises a content provider 12, a service provider 14, and a viewer unit 16.

Content provider 12 is a media company which provides digital content in the form of individual digital content units 30 such as an individual movie or a series of movies (e.g., Lord of the Rings trilogy), individual television programs or television series (e.g., 2006 season of The Sopranos), music videos, instructional programs, live or recorded sporting events, live or recorded concerts and other forms of digital content. Content provider 12 produces and distributes digital content units 30 for sale to consumers, as well as providing digital content units 30 to service provider 14 for direct sale consumers via a network 50, such as the World Wide Web or other network. In one embodiment, the digital content unit 30 is released in a variety of formats and venues, including but not limited to, a theatre 32, DVD 34, media-on-demand (MOD) 36 (e.g., webcasting, pay-per-view, video-on-demand, etc.), television 38 (i.e., network broadcast, cable, satellite, etc.), and a portable media file 40 (e.g., video files configured to played on a portable media device). In one aspect, a media-on-demand format 36 comprises a selection of digital content that is downloadable via the internet or viewable as a streaming digital content. In addition, content provider 12 produces and distributes one or more digital content samples 60, which are samples of digital content unit 30 and representative of at least a portion of an entire digital content unit 30. The digital content sample 60 is used by service provider 14 and content provider 12 to promote sales or interest in the digital content unit 30. In one embodiment, a digital content sample 60 comprises a movie screener, a video trailer, a clip of a television program, an excerpt of a live recording, a sample of a sporting event, a sample of an instructional program, a sample of concert, a compilation of clips of a program, and the like. In one aspect, a sample comprises a portion of a digital content unit 30 for a past event or program, but which is substantially related to or similar to a future event or program that is included in a digital content unit 30 being promoted and sold. Accordingly, in some instances, the sample is not strictly taken from a particular digital content unit 30 that is being promoted and sold, but from other digital content units 30.

In one embodiment, one or more digital content samples 60 are offered to a viewer (via viewer unit 16) in the form of a promotional display regarding a digital content unit and including, but not limited to, the digital content sample 60, advertisements, photos or music related to the digital content unit 30, etc.

Accordingly, as illustrated in FIG. 1, service provider 14 comprises an intermediary between the viewer unit 16 and content provider 12 and operates a web portal, social network service, internet protocol television (IPTV), or other network-based service to promote and sell digital content units 30 in the formats provided by content provider 12. In one embodiment, service provider 12 operates a publicly accessible network site or portal configured to promote digital content units 30 via promotional displays of digital content samples 60.

In one aspect, viewer unit 16 comprises an interface device configured to enable a viewer to access the video service offered by service provider 14. In one embodiment, viewer unit 16 comprises a desktop computer, laptop computer, or a set-top box. In another embodiment, viewer unit 16 comprises a portable media player, wireless phone, personal digital assistant, handheld computer, head-mountable video display glasses, and combinations thereof.

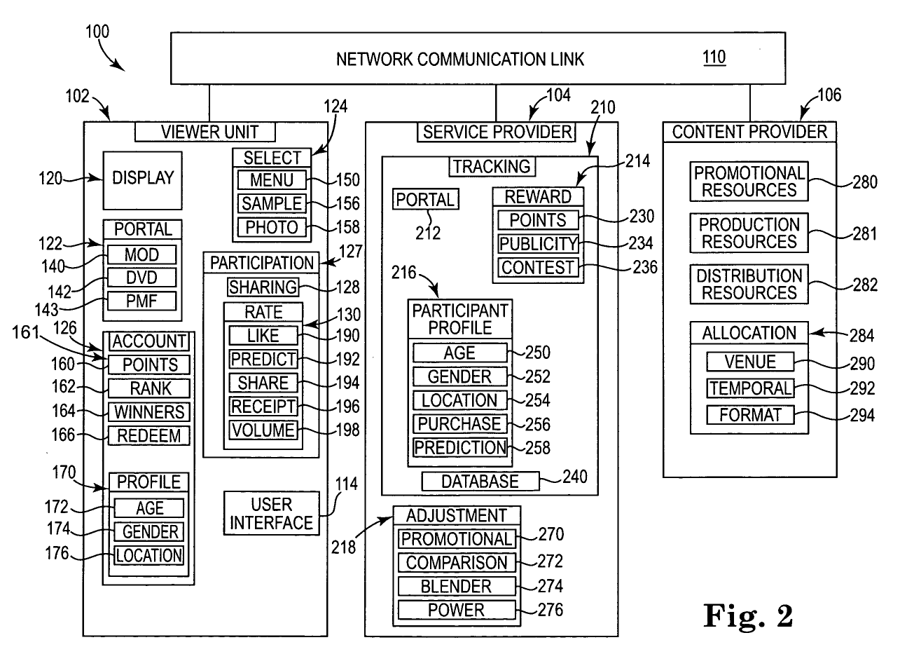

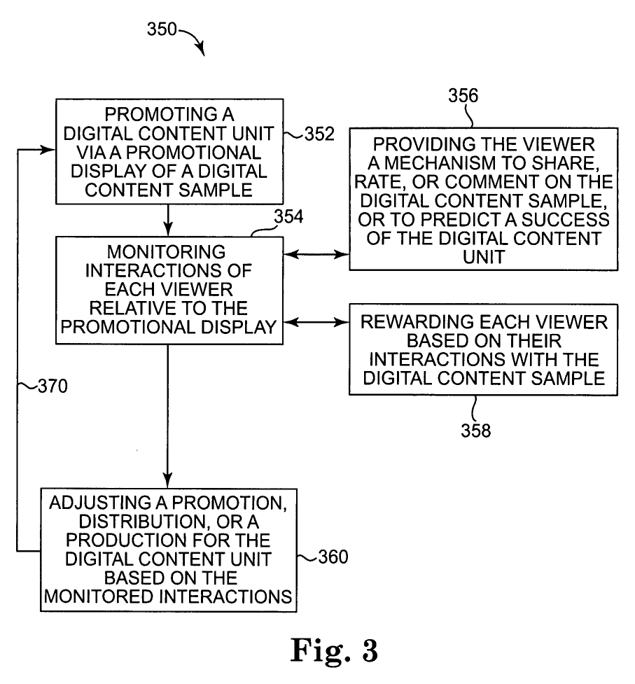

As described more fully in association with FIGS. 2-3, service provider 14 makes digital content units 30 (obtained from content provider 12) available for purchase and uses promotional displays of digital content samples 60 to promote the sale of current and future digital content units 30. Accordingly, this arrangement encourages viewer activity at network site(s) operated by service provider 14. In one embodiment, service provide 14 provides a participation mechanism to encourage a viewer (via viewer unit 16) to interactively view, share, and/or rate a digital content sample 60, as well as to predict whether the digital content unit 30 will be a commercial success. In another embodiment, the service provider 14 provides a reward mechanism to further induce viewer participation and reward viewers for their participation in interacting with a digital content sample 60.

FIG. 2 is a block diagram of digital content promotion system 100, according to one embodiment of the present disclosure. As illustrated in FIG. 2, system 100 comprises viewer unit 102, service provider 104, content provider 106, and network communication link 110. In one embodiment, viewer unit 102, service provider 104, and content provider 106 comprise substantially the same features and attributes as viewer unit 16, service provider 104, and content provider 106, respectively, as previously described in association with FIG. 1. In one aspect, viewer unit 102, service provider 104, and content provider 106 communicate with each other at least through a network communication link 110. In one aspect, the network communication link 110, as used herein, includes an Internet communication link, an intranet communication link, or similar high-speed communication link, each of which enable wired and/or wireless communication.

In one embodiment, as illustrated in FIG. 2, viewer unit 102 comprises user interface 114, display 120, portal 122, select module 124, account module 126, and participation mechanism 127. In one embodiment, the participation mechanism comprises sharing mechanism 128 and rating mechanism 130.

In one embodiment, user interface 114 of viewer unit 102 operates via support of display 120 and is configured to enable selection and control of the various components, parameters, functions and modules of viewer unit 102 to interact with digital content samples 60 provided by service provider 104. Moreover, the various components, parameters, functions, and modules of viewer unit 102 illustrated in FIG. 2 represent actual functions supported by software, firmware, hardware, etc. as well as displayable and selectable features of user interface 114. For example, in one embodiment, user interface 114 of viewer unit 102 is provided by and/or operates via support and control of service provider 104. Finally, in one embodiment, the components, parameters, functions, and modules of viewer unit 102 are not strictly limited to the arrangement shown in FIG. 2 and can be arranged into different combinations to achieve the same functions described herein.

In one embodiment, portal 122 comprises a network site, such a site on the World Wide Web, operated by the service provider 104 and tailored to drive viewer traffic at portal 122 with the aim of increasing participation in accessing digital content samples 60 and ultimately in increasing sales of digital content units 30 (whether or not they are directly represented by a digital content sample 60 available at portal 122). In one non-limiting example, the portal 122 offers digital content unit 30 for sale in a variety of formats, such as media-on-demand (MOD) format 140, a DVD format 142, and/or a portable media file (PMF) format 143.

In one embodiment, select module 124 of viewer unit 102 includes a menu function 150 that enables a consumer to select a digital content unit 30 or a digital content sample 60 for access from a menu of choices. In one aspect, the menu lists the digital content selections (digital content units 30 or digital content samples 60) by categories, subjects, themes, or favorites and also provides a search capability.

In one aspect, select module 124 comprises a sample function 156 to enable the consumer to select a digital content sample 60 (i.e., a movie screener, a video trailer, a clip of a television program, excerpt of a live recording, a compilation of clips of a program) for viewing instead of accessing and viewing the complete digital content unit 30. In another aspect, a photo function 158 of select module 124 comprises digital content samples 60 in form of still photos or images selected from a digital content unit 30, such as a movie, television program, or video segment.

It will be understood by those skilled in the art the select module 124 is illustrated as part of viewer unit 102 because the consumer uses select module 124 to access digital content samples 60 (and/or digital content units 30) but that select module 124 is provided by service provider 104. It also will be understood by those skilled in the art the portal 122 is illustrated as part of viewer unit 102 because the consumer uses portal 122 to access digital content samples 60 (and/or digital content units 30) but that portal 122 is provided by service provider 104 for access via viewer unit 102. In one embodiment, select module 124 forms a portion of, and is incorporated within, portal 122.

The participation mechanism 127 of viewer unit 102 encourages and fosters a viewer to interact with a digital content sample 60 at the network site supported by service provider 104, which simultaneously gauging the interest of the viewers toward the digital content samples 60 and digital content units 30.

In one embodiment, the participation mechanism 127 comprises a sharing mechanism 128, which enables a viewer to share a digital content sample 60 with another viewer. The sharing mechanism 128 comprises an activatable function in user interface 114 of viewer unit 102 that initiates electronic transmission of the digital content sample 60 or of a link for the digital content sample 60 to another viewer.

In one embodiment, the participation mechanism 127 comprises the a rating mechanism 130, which enables a viewer to provide their reaction regarding a digital content sample 60 while simultaneously promoting the digital content units 30 to those viewers. In one aspect, the viewer is able to provide their own rating of the digital content sample 60, as well as see individual ratings or aggregate ratings by other viewers.

In one embodiment, as illustrated in FIG. 2, rating mechanism 130 includes a like function 190, a prediction function 192, as well as market share parameter 194, a receipt parameter 196, and a volume parameter. The like function 190 enables the viewer to indicate their general like or dislike of a digital content sample 60 via a rating scale and/or reviewer comments input field. The prediction function 192 enables the viewer to make a prediction, based on the digital content sample 60, regarding a future commercial success or future critical acclamation (e.g., Academy Award, Emmy award, Grammy award, etc.). The viewer, via the prediction function 192, also can learn about other viewer's predictions regarding a digital content unit 30 that were based on the same or different digital content sample 60. The prediction function 192 enables the viewer to make the predictions according to sales receipts (e.g., box office receipts, web-based sales, etc.) via the receipts parameter 196 or according to volume (e.g., number of units sold, rate of sale, number of viewers, etc.) via the volume parameter 198.

In one embodiment, the market share parameter 194 enables a viewer to make a prediction regarding the success or popularity of a digital content unit 30 according to a market share criteria. In one aspect, the market share criteria comprises a viewer-based tracking system, such as the Nielsen rating system used to measure the market share a particular TV program has garnered in a given time period.

In one embodiment, the account module 126 of viewer unit 102 enables the viewer to establish and maintain a relationship with the service provider 104 for accessing the digital content units 30 and/or digital content samples 60. In one embodiment, the relationship is a pay-based arrangement in which the viewer pays for digital content units 30 on a unit-by-unit basis or on a subscription basis. In another embodiment, the relationship allows the viewer to access at least some of the digital content units 30 for free.

In one embodiment, account module 126 comprises a profile module 170 configured to store a profile of the viewer to enable service provider 104 (and consequently content provider 106) to better track the demographic parameters affecting sales of a digital content unit 30 or a genre of digital content units 30. In one aspect, as illustrated in FIG. 2, profile module 170 comprises an age parameter 172, a gender parameter 174, and a location parameter 176. The age parameter 172 tracks the age of the viewer while gender parameter 174 stores the gender of the viewer. The location parameter 176 tracks the geographic location (i.e., region, country, state, county, city, etc.) of the viewer's residence and/or the geographic location from which the viewer accesses the digital content sample 60. In one embodiment, the location parameter 176 also includes a venue function for tracking viewer access to digital content samples 60 among different venues (e.g., home, hotel, work, mobile, school, etc.) within a given geographic location. This venue information enables the service provider 104 and/or content provider 106 to understand more about the viewer and form an association between their behavior/lifestyle and their like or dislike of a digital content unit 30. This information is then used by the content provider 106 or service provider 104 to adjust their promotion, production, and/or distribution of the digital content samples 60 and/or digital content units 30 in the hopes of increasing the success of the digital content units 30.

In one embodiment, as illustrated in FIG. 2, account module 126 of viewer unit 102 comprises an array 161 of reward functions 160-166 that act together as part of a reward mechanism to reward interaction by a viewer with a digital content sample 60 via participation mechanism 127. Such viewer interactions with digital content samples 60 include, but are not limited to, use of the sharing mechanism 128 and rating mechanism 130 (including the prediction function 192). In addition, the interest garnered via the participation mechanism 127 acts to promote general interest in the network site (e.g., portal 122) offered by service provider 104 and to further promote one or more digital content units 30. Accordingly, operation of the reward mechanism (provided via array 161 of reward functions 160-166) helps to convert the interest in the digital content unit 30 into actual commercial success of the digital content unit 30.

In one aspect, the array 161 of rewards functions 160-166 include a points function 160, a ranking function 162, a winners function 164, and a redeem function 166. The points function 160 awards promotional points to the viewer for their participation by using the sharing mechanism 128 and/or the rating mechanism 130 (including the prediction function 192). In addition, the points function 160 tracks and displays the number of promotional points accumulated by the viewer. In some instances, an additional reward or a higher reward (than an initial reward) is provided to viewers that make accurate predictions of future commercial success of a digital content unit 30. As described more fully later, in one embodiment, service provider 104 tracks the behavior of select viewers that develop a history of making accurate predictions and then provides those viewers' predictions to content provider 106 to assist content provider 106 in adjusting the promotion, production, and distribution of digital content units 30 and digital content samples 60.

The ranking function 162 of array 161 of rewards functions 160-166 enables display of a viewer's rank among other viewers in their volume or frequency of viewing, sharing, and/or rating digital content samples 60 or in their accuracy in predicting a success (e.g., commercial, award-based, etc.) of a digital content unit 30. The winners function 164 of array 161 of rewards functions 160-166 tracks which viewers have won a rating contest regarding a particular digital content unit 30 and displays information about the winning participant to encourage viewers to participate by using the rating mechanism 130, sharing mechanism 128, and/or prediction function 192.

The redeem function 166 of array 161 of rewards functions 160-166 tracks a number and/or a type of promotional points given as rewards for a particular viewer or for viewers in aggregate. This redeem function 166 enables the viewer to redeem their promotional points for prizes, purchase of digital content units 30, or for premium features offered by service provider 102, etc. In addition, service provider 104 and/or content provider 106 use this information about rewards to promote their digital content units 30 by creating excitement and enticing viewers to participate in rating a digital content sample 60 or predicting the success of a digital content unit 30.

In one embodiment, the array 161 of reward functions 160-166 is supported by, and acts in cooperation with, reward mechanism 214 of service provider 104, as described more fully later within this present disclosure.

As illustrated in FIG. 2, service provider 104 comprises tracking module 210 and adjustment module 218 with tracking module 210 including a portal mechanism 212, a reward mechanism 214, and participant profile module 216.

In one embodiment, tracking mechanism 210 enables service provider 104 to track viewer interactions with a promotional display, such as a digital content sample 60, viewable in portal 122 of viewer unit 102. In one aspect, portal mechanism 212 of tracking mechanism 210 supports and operates the previously described network portal 122 accessible in viewer unit 102.

A reward mechanism 214 of service provider 104 supports and acts in cooperation with the array 161 of reward functions 160-166 (of account module 126 of viewer unit 102), thereby enabling the service provider 104 to provide and track rewards to viewers based upon the viewer's interaction (via participation mechanism 127 of viewer unit 102) with digital content samples 60 at the web-based service provided by service provider 104. In one embodiment, as illustrated in FIG. 2, the reward module 214 comprises a points function 230, a publicity function 234, and a contest function 236.

In one aspect, the points function 230 provides and tracks promotional points for each viewer in order to promote viewer activity within portal 122 of viewer unit 102. In one embodiment, the points function 230 tracks which digital content units 30 and/or which digital content samples 60 generate the most promotional points for viewers to determine which traits within those respective digital content samples 60 are more effective in garnering interest from viewers. In one aspect, this interest is gauged or measured by the volume or frequency that viewers (individually or in aggregate) choose to rate a digital content sample 60, choose to share a digital content sample 60 with another viewer, choose to make a prediction regarding the future success of a digital content sample 60, and/or choose to purchase digital content units 30 from service provider 104. Moreover, the accuracy of their predictions is used to measure the interest associated with a particular digital content sample 60. In addition, in another aspect, this interest is also measured by the volume and/or frequency that a digital content sample 60 is accessed.

In another aspect, via points function 230 of reward mechanism 214, promotional points are awarded to viewers to encourage viewer participation through use of the participation mechanism 127 of viewer unit 102, including the use of sharing mechanism 128 and the rating mechanism 130 (including the prediction function 192). In addition, service provider 104 controls and adjusts a frequency, a volume, and/or a type of promotional points to encourage specific behaviors by viewers. In one embodiment, the control over promotional points is used to promote a specific digital content sample 60 for one digital content unit 30 over a digital content sample 60 of another digital content unit 30. In addition to granting a first reward for merely participating (e.g., viewing, sharing, rating, predicting), points function 230 provides a second reward, higher than the first reward, to a viewer that makes accurate predictions of future commercial success of digital content units 30.

In one aspect, a publicity function 234 of reward mechanism 214 of service provider 104 enables service provider 104 to promote its web-based services and viewer participation in accessing digital content samples 60. In another aspect, publicity function 234 enables service provider 104 to highlight and reward specific viewers for their frequency and/or volume of use of the participation mechanism 127 including the use of sharing mechanism 128, and the rating mechanism 130 (including the prediction function 192). The publicity function 234 is also used by service provider 104 to publicly identify specific viewers among other viewers (within the web-based service) that make accurate predictions regarding a future success (e.g. commercial success or critical acclamation) of a digital content unit 30. This publicity acts a reward to encourage more viewers to participate in rating and sharing digital content samples 60, as well as in making predictions regarding digital content units 30, thereby further promoting those digital content samples 60 and digital content units 30.

In one aspect, publicity function 234 of reward mechanism 214 of service provider 104 acts in support of, and in cooperation with ranking function 162 of array 161 of reward functions 160-166 of viewer unit 102. Accordingly, in one aspect, service provider 104 calculates a rating for the accuracy of an individual viewer or of a group of viewers in predicting future commercial success for a digital content unit 30. Next, a ranking of the relative accuracy among those respective individual viewers or groups of viewer is determined and then published via network portal 122. In another aspect, this publication regarding the accuracy and/or relative rank of the respective viewers is made within a predetermined time frame including, but not limited to, a release date of the digital content unit 30, a predetermined day of the week, and/or a predetermined time of day. Accordingly, the viewers that make accurate predictions are rewarded while simultaneously providing further promotion of one or more digital content units 30 by attracting viewers (i.e., accurately predictive viewers, inaccurately predictive viewers, and/or non predicting viewers) to return to the participation mechanism 127 at network portal 122 on a regular basis to observe the ratings or rankings of the respective viewers, as well as to view other promotional material such as other digital content samples 60.

In one embodiment, contest function 236 enables service provider 104 to have contests for viewers based on a volume of ratings made and/or a volume of sharing digital content samples 60, as well as based on their accuracy in predicting future success of a digital content unit 30. In cooperation with publicity function 234 and points function 230, contest function 236 rewards viewers for their participation in specific contests and if they are the winning participants in a specific contest. Together, this activity by viewers, as generated by service provider 104, increases promotion and sales of digital content units 30.

In one embodiment, service provider 104 comprises a participant profile module 216 that enables service provider 104 to track demographic information about viewers that access services by service provider 104. This information is shared with content provider 106 to assist content provider 106 in tailoring its promotion, production, and/or distribution of digital content unit 30 or digital content sample 60. In one aspect, as illustrated in FIG. 2, participant profile module 216 tracks an age, gender, and location of a viewer via age parameter 250, gender parameter 252, and location parameter 254, respectively in a manner consistent with comparable parameters 172-176 of profile module 170 of viewer unit 102. Accordingly, participant profile module 216 supports, and acts in cooperation with, profile module 170 of account module 126 of viewer unit 102.

In addition, participant profile module 216 of service provider 104 comprises a purchase parameter 256 that tracks a type, a frequency, and a volume of purchases by a viewer to establish a history of purchases for that viewer. The purchase parameter 256 also tracks a date of purchase which can be associated with the date or dates that a particular digital content sample 60 was accessed to identify more effective digital content samples 60. In one aspect, this information is used with the other demographic information (e.g., age, gender, location, etc.) to determine which style of digital content sample 60 is more appealing to member of a given demographic class.

In another aspect, the participant profile module 216 of service provider 104 comprises a prediction parameter 258 configured to associate accurate predictions of future success of a digital content unit 30 (made by the viewer via prediction function 192 of rating mechanism 130 of viewer unit 102), using one or more digital content samples 60 accessed by the viewer. This information is used to identify traits within those digital content samples 60 considered to be most effective in triggering an accurate prediction from the viewer. Likewise, the prediction parameter 258 facilitates identifying traits within other digital content samples 60 to determine traits that lead to inaccurate predictions regarding the future success of a digital content unit 30. In one embodiment, prediction parameter 258 also tracks and stores a history of predictions for each viewer by which service provider 104 can identify viewers that consistently make accurate predictions. In one aspect, when a particular viewer shows a strong history of making accurate predictions, this information is shared with content provider 106 to allow content provider 106 to use future predictions by that viewer in allocation their promotion, production, and distribution of digital content units 30.

In one embodiment, the behavioral information about viewers (i.e., their interaction with digital content samples 60) and its association with digital content units 30 and digital content samples 60 is stored in memory in a database 240. In one embodiment, database 240 comprises a relational database configured to associate the demographic profile and account profile (including data regarding their interactive behavior) of each viewer with digital content samples 60 accessed by the respective viewer. In one aspect, using this database 240, service provider 104 determines one or more target markets for the digital content units 30, and the service provider 104 is better positioned to deploy digital content samples 60 (representing a particular digital content unit 30) tailored to strike a positive reaction from members of the target market. Some non-limiting examples of different target markets include college age males in urban areas, senior citizen retirees in rural areas, married female business professionals, etc. In addition, service provider 104 also can use several different network sites, with each respective network portal 122 intended to suit and attract members of one of the different target markets. Alternatively, service provider 104 operates a single network site with different areas, each particularly suited to the different respective target markets.

In another aspect, in a manner substantially similar for purchase parameter 256, the accurate or inaccurate predictions of a viewer are associated with other demographic information via age parameter 250, gender parameter 252, location parameter 254, and/or purchase parameter 256 to track and determine which factors lead to accurate or inaccurate predictions. This information is used to adjust the promotion, production, and/or distribution of digital content units 30 via content provider 106.

In one embodiment, service provider 104 also comprises adjustment module 218 that comprises a tool for recognizing viewer patterns and making adjustments in the offering of digital content samples 60 to increase the effectiveness of the digital content samples 60. In one embodiment, as illustrated in FIG. 2, adjustment module 218 comprises a promotional function 270, a comparison function 272, a blender function 274, and a predictive power function 276. In one aspect, promotional function 270 of adjustment module 218 tracks the volume and/or frequency of viewing, sharing, and rating each digital content sample 60.

Moreover, in another aspect, promotional function 270 also tracks the volume and/or frequency that viewers predict success for a given digital content unit 30 based on a specific digital content sample 60. This information is monitored, via predictive power function 276 of adjustment module 218, to determine a predictive power of each digital content sample 60 for a digital content unit 30. In one aspect, this measurement of predictive power for a digital content sample 60 is performed substantially continuously while in another aspect, it is performed at periodic intervals.

In one aspect, comparison function 272 of adjustment module 218 evaluates the effectiveness of a digital content sample 60 in promoting a digital content unit 30 or similar digital content units 30. In one embodiment, via predictive power function 276, comparison function 272 compares the effectiveness of two or more digital content samples 60 relative to each other in promoting the same digital content unit 30 and in causing accurate predictions of the commercial success of the digital content unit 30. Less effective digital content samples 60 are no longer used while more effective digital content samples 60 are made more widely available or aimed at particular demographic targets. For example, service provider 104 can offer several different portals 122 for promoting digital content units 30 with each respective portal targeted to a different demographic group (18 year old student v. 60 year old retiree) and/or different geographic location (e.g. San Francisco, Calif. v. Minot, N. Dak.).

Blender function 274 of adjustment module 218 enables service provider 104 to combine portions of different digital content samples 60 by blending them together to form a new digital content sample 60. In one aspect, the portions of the different digital content samples 60 that are the most effective portions of their respective samples 60 are selected for inclusion into a compilation forming a new digital content sample 60. In another aspect, the relative effectiveness of an entire digital content sample 60 or portions of a digital content sample 60 is determined via gathering statements from a comments section, such as provided via the rating mechanism 130 of viewer unit 102.

In one embodiment, service provider 104 makes an adjustment in promoting digital content unit 30 by completely replacing the digital content sample 60 with a new digital content sample 60, or by offering additional alternative digital content samples 60.

In one embodiment, as illustrated in FIG. 2, system 100 includes a content provider 106, which comprises promotional resources 280, production resources 281, distribution resources 282, and an allocation module 284. The allocation module 284 is configured for allocating the promotional resource 280, production resource 281, and/or distribution resource 282.

Production resource 281 enables content provider 106 to create digital content samples 60 from portions of digital content units 30 and to create additional components such as photos, advertisements, and the like related to the digital content unit 30. Promotional resource 280 enables content provider 106 to use the digital content samples 60 and other production components to create one or more promotional displays that feature a digital content sample 60 configured to promote a digital content unit 30. Distribution resource 282 enables content provider 106 to make the digital content unit 30 and digital content samples 60 available through distribution channels for placement in brick-and-mortar retailers and on-line retailers, such as service provider 104.

In one embodiment, allocation module 284 comprises a venue parameter 290, temporal parameter 292, and format parameter 294.

In one embodiment, as illustrated in FIG. 2, allocation module 284 comprises a venue parameter 290, temporal parameter 292, and format parameter 294. Venue parameter 290 of allocation module 284 controls a venue, such as a theatre, store sales, or on-lines sales through which a digital content unit 30 is to be distributed.

Temporal parameter 292 of allocation module 284 controls a time period in which a digital content unit 30 will be released for purchase by viewers. In one embodiment, temporal parameter 292 enables the content provider 106 to select distribution (using distribution resources 282) of a digital content unit 30 within one or more distribution segments including, but not limited to, a theatre release, a DVD release, a pay-per-view release, a media-on-demand (MOD) release, a premium subscription release (e.g., cable, satellite, broadband services), a television broadcast release, and/or release via a web-based network service, such as via service provider 104. In one aspect, content provider 106 uses the information obtained from service provider 104 regarding a predicted success of a digital content unit (including demographic information from participant profile module 216 of service provider 104 and profile module 170 of viewer unit 102) to target one or more distribution segments. This arrangement allows the content provider 106 to focus their promotional resources 280, production resources 281, and distribution resources 282 to on market niches likely to maximize their sales in particular digital content units 30 or classes of digital content units 30.

In one aspect, format parameter 294 of allocation module 284 controls selection over which formats will be used to distribute the digital content unit 30. In some instances, such as for a popular digital content unit 30 that was successful in the theatre, all formats are used to further distribute the digital content unit 30. In other situations, such as a digital content unit 30 that did not do well in the theatres, fewer formats are used to further distribute the digital content unit 30. In yet other situations, such as a digital content unit 30 that has smaller financial backing or less access to established distribution channels, more formats after a theatre release or instead of a theatre release are used to distribute the digital content unit 30. As will be understood by those skilled in the art, a close relationship exists between the venue parameter 290 and the format parameter 294. For example, when a content provider 106 targets sale to consumers in home, the digital content units 30 would typically be sold as direct mail DVDs, portable media files (PMF) available on-line via the World Wide Web, or via media-on-demand or pay-per-view. On the other hand, if the content provider 106 believes, based on a viewer's interaction with the digital content samples 60 at network portal 122, that in store sales or direct mail sales (controlled via venue parameter 290) will not be effective, then the content provider 106 can choose not to release the digital content unit 30 in the DVD format. Instead, the content provider 106 limits the release of the digital content unit 30 on-line via a network-based service for downloading or streamcasting digital content units 30. In one aspect, this distribution path is taken for older digital content units 30 that were not previously released on DVD.

In one aspect, the network-based services offered by service provider 104 are especially suited to promoting older digital content units 30 or more obscure digital content units 30 because the portal 122 (available on the network or World Wide Web) can provide a virtually unlimited number of digital content samples 60 that could not be provided in a more conventional venue, such as a brick-and-mortar retailer. The service offered via the portal 122 is relatively immune to the rapid sales cycles and related shelf space issues that affect brick-and-mortar retailers. Instead, the network-based service has virtually no time limit on how long a digital content unit 30 is offered for sale, as little or no pressure exists for selling a minimum quantity of more obscure digital content units 30. This arrangement, in turn, enables content provider 106 (via allocation module 284) to adjust or allocate its promotional resources 280, production resources 281, and distribution resources 282 in response to a positive or negative reaction to digital content samples 60 and/or a predicted success or failure of the digital content unit 30. Accordingly, the content provider 106 becomes well positioned to maximize their sales while shifting their costs away from ineffective promotion, production, or distribution.

FIG. 3 is a flow diagram of a method 350 of promoting digital content, according to one embodiment of the present disclosure. In one embodiment, method 350 is performed using one or more embodiments previously described in association with FIGS. 1-2. In another embodiment, other components and systems are used to perform method 350 of promoting digital content.

As illustrated in FIG. 3, at box 352, a digital content unit is promoted via a promotional display. In one embodiment, the promotional display is a sample of the digital content unit, i.e., a digital content sample. In one aspect, the promotional display is offered via network site (e.g., web page) operated by a service provider with the network site configured to promote and sell the digital content unit on behalf of a content provider. In another aspect, the content provider produces and/or distributes the digital content unit and the digital content sample.

At box 354, method 350 comprises monitoring interactions of each viewer relative to the promotional display. In one embodiment, as illustrated at box 356, the network site (operated by the service provider) provides the viewer a participation mechanism to share the promotional display (such as a digital content sample) with another viewer and to rate the viewer's like or dislike of the promotional display (and the digital content unit it represents). In one aspect, the participation mechanism also provides the viewer an opportunity to comment on the promotional display and/or to make a prediction about the future commercial success of the digital content unit represented by the promotional display. Accordingly, the participation mechanism entices viewers to interact with the promotional display (e.g., digital content sample) with their participation acting to indirectly promote the digital content unit. In one aspect, the viewer's participation acts to sell the digital content unit to the viewer.

In another embodiment, as illustrated at box 358, the service provider operates a reward mechanism at the network site to reward each viewer based on their interaction with the digital content sample of the promotional display. In one aspect, the viewer is rewarded with promotional points for accessing the digital content sample or for sharing the digital content sample with another viewer. In another aspect, the viewer is rewarded for commenting on the digital content sample or for rating the digital content sample. In another aspect, the viewer is rewarded for making predictions on the future commercial success of the digital content unit represented by the digital content sample with additional rewards being provided to each viewer that is accurate in their prediction. The rewards are direct prizes or promotional points which are accumulated based on the viewer's interaction with digital content samples at the network site. The promotional points are used to acquire digital content units or other merchandise, such as memorabilia related to the digital content unit.

At box 360, as illustrated in FIG. 3, method 350 comprises adjusting the promotion, production, or distribution for the digital content unit based on the monitored interactions of the viewer with the promotional display (e.g., digital content sample). In one embodiment, adjusting the promotion of the digital content unit comprises producing an alternative digital content sample believed to be more effective in inducing viewers to participate and/or interact in a positive manner with the alternative digital content sample for the digital content unit. In one embodiment, as illustrated in FIG. 3, a feedback pathway 370 comprises the content provider providing the alternative digital content sample to replace an original digital content sample that was determined, based on monitoring viewer interactions with the original digital content sample, to be ineffective in promoting the digital content unit. In other words, the alternative digital content sample reflects feedback from the viewers that the original digital content sample was not appealing, causing the content provider to modify or replace the digital content sample in an attempt to better promote the digital content unit via the modified or alternative digital content sample. In another aspect, viewer access to the original digital content sample is not prevented but additional, different digital content samples (representing the digital content unit) are made available for interaction by viewers.

In another aspect, a distribution of the digital content unit is adjusted based on monitored interaction of viewers with the digital content sample. In one example, a positive interaction of viewers with the digital content sample leads to a content provider making the digital content unit available in many different formats and in a greater number of distribution time periods. On the other hand, a negative interaction of viewers leads a content provider to provide the digital content unit in fewer formats and fewer distribution time periods.

In one embodiment, the respective positive or negative interaction of the viewers is associated with parameters (age, gender, location) of a demographic profile and account profile (e.g., sharing, rating, comments, purchases, predictions, etc.) of each viewer, and in turn, the content provider adjusts further promotion, distribution, and production of the digital content unit to according to the demographic and account parameters corresponding to positive interaction with the digital content unit.

Accordingly, method 350 provides a mechanism for viewers to interact with a promotional display (e.g., digital content sample) and a feedback loop for driving promotion of the digital content unit toward a more effective promotional display while also using that feedback to adjust allocation of distribution and promotion resources to increase the commercial success of the digital content unit.

In one aspect, method 350 facilitates a content provider to make prudent adjustments for promotion, production, and distribution for the time horizon in which the content provider can expect to maximize sales of the digital content unit. Accordingly, via method 350, instead of pulling all distribution resources out of a digital content unit that is received poorly in a theatre release (or that does not even have a theatre release), the content provider redirects the distribution resources and available format of the digital content unit to formats and venues (e.g., DVD, MOD, PMF, etc.) more suited to the particular digital content unit, such as a niche market within a diverse, broad collection of digital content units.

Embodiments of the present disclosure facilitate a content provider to promote and sell digital content units via a network-based service provider accessible to a viewer. The service provider entices the viewer with a portal configured to let the viewer access, share, and/or rate a digital content sample that represents the digital content unit. In addition, the service provider maintains a reward mechanism for rewarding viewer participation in accessing, sharing, and rating the digital content samples, as well as for predicting the likelihood of a commercial success of a digital content unit. By employing these tools, a service provider uses digital content samples to promote and sell digital content units, while the content provider adjusts it promotion, production, and distribution of digital content units based on viewer interactions with the digital content samples.

Components of the present disclosure may be implemented in hardware via a microprocessor, programmable logic, or state machine, in firmware, or in software within a given device. In one aspect, at least a portion of the software programming is web-based and written in HTML and JAVA programming languages, including links to graphical user interfaces, such as via windows-based operating system. The components may communicate via a network using a communication bus protocol. For example, embodiments of the present disclosure may or may not use a TCP/IP protocol suite for data transport. Other programming languages and communication bus protocols suitable for use embodiments of the present disclosure will become apparent to those skilled in the art after reading the present application.

Components of the present disclosure may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that the claimed subject matter be limited by the claims and the equivalents thereof.

What is claimed is:

1. A method of promoting digital content, the method comprising:
promoting at least one digital content unit to a plurality of viewers via a first digital content sample accessible at a network site;
monitoring an interaction of each respective viewer relative to the first digital content sample, the interaction including at least one of viewing, sharing, rating the first digital content sample, or predicting a commercial success of the at least one digital content unit;
rewarding each respective viewer that participates in viewing, sharing, rating, or predicting; and
adjusting at least one of promotion, production, and distribution of the at least one digital content unit based upon the monitored interaction of each respective viewer relative to the first digital content sample.

2. The method of claim 1 wherein rewarding each respective viewer comprises:
providing a first reward for rating the first digital content sample and providing a second reward, higher than the first reward, for accurately predicting the actual commercial success of the at least one digital content unit.

3. The method of claim 1 wherein promoting the at least one digital content unit comprises:
providing a sharing mechanism for viewers to share access to the first digital content sample with other viewers via the network site.

4. The method of claim 1 wherein promoting the at least one digital content unit comprises:
providing, via the network site, a different, second digital content sample representing the at least one digital content unit;
evaluating an effectiveness of the first digital content sample, relative to the second digital content sample, via measuring whether the first digital content sample or the second digital content sample causes a greater number of viewers to interact with the second digital content sample, wherein the measurement tracks at least one of the following viewer actions:
sharing the second digital content sample with another viewer rating the second digital content sample;
commenting on the second digital content sample;
making a prediction regarding a commercial success of the at least one digital content unit; or
making accurate predictions regarding the commercial success of the at least one digital content.

5. The method of claim 4, comprising:
determining the commercial success of the at least one digital content unit via at least one of a market share parameter, a sale receipts parameter, or a sales volume parameter.

6. The method of claim 4 wherein promoting the at least one digital content unit comprises:
replacing the first digital content sample with the second digital content sample at the network site when the second digital content sample is more effective than the first digital content sample in promoting the at least one digital content unit.

7. The method of claim 4 wherein promoting the at least one digital content unit comprises:
providing a plurality of digital content samples, including the respective first digital content sample and the second digital content sample, at the network site.

8. The method of claim 7 wherein promoting the at least one digital content unit comprises:
producing, based on a relative effectiveness of the respective digital content samples, a compilation digital content sample comprising a combination of two or more different respective digital content samples.

9. The method of claim 1 wherein promoting the at least one digital content unit comprises:
identifying a series of distribution segments for the at least one digital content unit; and
targeting, based upon the predicted commercial success of the at least one digital content unit, distribution of the at least one digital content unit in at least one of the respective distribution segments.

10. The method of claim 9 wherein the distribution segments include at least one of a theatre release, a DVD release, a media-on-demand release, a web-based network release, or a television broadcast segment.

11. The method of claim 1 wherein the at least one digital content unit comprises at least one of at least one movie, at least one television program, at least one music video, at least one instructional program, at least one sporting event, or at least one concert.

12. The method of claim 1 wherein the first digital content sample comprises at least one of a movie screener, a video trailer, an excerpt of a television program, a sample of a sporting event, a sample of an instructional program, a sample of a concert, or at least one photo.

13. A digital content promotion system comprising:
a network portal including at least one interactive promotional display for a digital content unit;
a tracking module including:
a rating mechanism configured to enable at least one participant to rate, via the network portal, the at least one interactive promotional display and to make a prediction of the commercial success of the digital content unit based on viewing of the first promotional display by the at least one participant; and
a reward mechanism in which the at least one participant is rewarded, via an account associated with the network portal, for an accurate prediction of the commercial success of the digital content unit; and
an allocation module configured to allocate, based on the predicted commercial success of the digital content unit, at least one of promotional resources, production resources, and distribution resources to maximize the commercial success of the digital content unit.

14. The digital content promotion system of claim 13 wherein the tracking module comprises:
a participant demographics module configured to track demographic parameters of the at least one participant, including at least one of:
an age parameter configured to identify an age of the at least one participant;
a gender parameter configured to identify a gender of the at least one participant;
a geographic location parameter configured to identify a location of the at least one participant;
a purchase history parameter configured to track a history of purchases of digital content units for the at least one participant; or
a prediction history parameter configured to track a history of predictions made by the at least one participant.

15. The digital content promotion system of claim 14 wherein the allocation module is configured to allocate the respective promotional resources, production resources, and the distribution resources based on demographic parameters of the at least one participant and according to an array of parameters including at least one of:
a temporal parameter configured to release the digital content unit in one or more distribution segments;
a venue parameter configured to release the digital content unit is one or more venues; or
a format parameter configured to release the digital content unit in one or more media formats.

16. The digital content promotion system of claim 13 wherein the reward mechanism comprises a contest module configured to reward the at least participant upon making an accurate prediction regarding the actual commercial success of the digital content unit, wherein the reward includes at least one of:
publicly identifying the at least one participant as a winner via the network portal within a predetermined time frame including at least one of a time interval from a release date of the digital content unit, a predetermined time of day, or a predetermined day of the week; or
granting the at least one winning participant a number of promotional points.

17. The digital content promotion system of claim 16 wherein the tracking module is configured to supply to a content provider at least one prediction of commercial success from the winning participant regarding future digital content.

18. A digital content promotion system comprising:
means for gauging interest, via an interactive network portal, based on interaction by a viewer with a first promotional display of at least one digital content unit to determine a predictive power of the first promotional display;
means for adjusting the first promotional display, via feedback from the means for gauging interest, to increase the predictive power of the first promotional display; and
means for allocating, based on the feedback from the means for gauging interest, at least one of a promotional resource, a production resource, and a distribution resource for promoting and selling the digital content unit.

19. The digital content promotion system of claim 18 wherein the means for gauging interest comprises:
a participation module configured to enable the viewer to view, share, or rate a digital content sample of the first promotional display, wherein the rating mechanism includes a prediction function configured to track predictions, by each viewer, of a commercial success of the digital content unit.

20. The digital content promotion system of claim 18 wherein the means for adjusting comprises:
an adjustment module configured to determine the predictive power of the first promotional display for actual commercial success for the at least one digital content unit based on at least one of a substantially continuous measurement or measurements at periodic intervals; and
a comparison module configured to offer a second promotional display and compare the predictive power of the first promotional display relative to a predictive power of the second promotional display of the actual commercial success for the at least one content digital unit.

21. The digital content promotion system of claim 18 wherein the means for allocating comprises:
a content distributor configured to direct promotional resources, production resources, or distribution resources for the at least one digital content, based on a demographic profile of the at least one participant, on the interest by the at least one participant in the first promotional display, and on the predicted commercial success of the at least one digital content unit.

22. The digital content promotion system of claim 18 wherein the first promotional display comprises a digital content sample.
